(19) United States
(12) Patent Application Publication
(10) Pub. No.: US 2011/0101936 A1
(43) Pub. Date: May 5, 2011

(54) LOW DROPOUT VOLTAGE REGULATOR AND METHOD OF STABILISING A LINEAR REGULATOR

(75) Inventor: Zhenhua Wang, Zurich (CH)

(73) Assignee: NXP B.V., Eindhoven (NL)

(21) Appl. No.: 13/001,401

(22) PCT Filed: Jun. 26, 2009
(86) PCT No.: PCT/IB09/52774

§ 371 Date: Dec. 23, 2010

(30) Foreign Application Priority Data
Jun. 26, 2008 (EP) 08104555.1

(51) Int. Cl. G05F 1/56

(52) U.S. Cl. 323/280

(57) ABSTRACT

A low dropout (LDO) voltage regulator comprises a regulating element (10) having an input (12), an output (14) and a control terminal (16), an error amplifier (22) having a non-inverting input (28) coupled to a node (30) of a potential divider sampling an output voltage (Vo) at the output (14) of the regulating element, an inverting input (24) coupled to a source (26) of a reference voltage (Vref) and an output coupled to the control terminal (16) of the regulating element, and means for generating an internal zero. The means for generating an internal zero comprises an operational amplifier (52) having a non-inverting input (54) coupled to the node (30) of the potential divider, an output (58) coupled to the non-inverting input (28) of the error amplifier, a resistive element (60) connected between the output and an inverting input (56) of the operational amplifier and a capacitive element (62) coupled between the inverting input of the operational amplifier and the source of reference voltage.

The present invention relates to a low dropout (LDO) voltage regulator and to a method of stabilising a linear regulator. The present invention has particular but not exclusive application to portable devices such as mobile phones, cordless extension phones, MP3 players and digital still cameras.

Unlike switch mode power supplies which require an off-chip inductor and generate switching noise, linear regulators and LDOs (called regulators thereafter) require only one capacitor and can convert an input voltage into a very stable supply voltage with much lower noise. These advantages make regulators widely used in noise-sensitive portable equipment, especially in wireless.

Loop stability has been top concern in designing because regulators are not unconditionally stable for all load conditions. A zero created by the equivalent series resistance (ESR) of the load capacitor is normally needed for the stability of the circuit. This method of frequency compensation, though still widely used in currently available commercial regulators, requires the users to use capacitors that have an ESR in a certain range specified by the manufacturer of regulators.

However, the ESR of capacitors is not well controlled and also not guaranteed by many capacitor manufacturers. Another problem is that with the specified ESR, which is typically in the range of ohms, a high voltage drop will be produced during load transition.

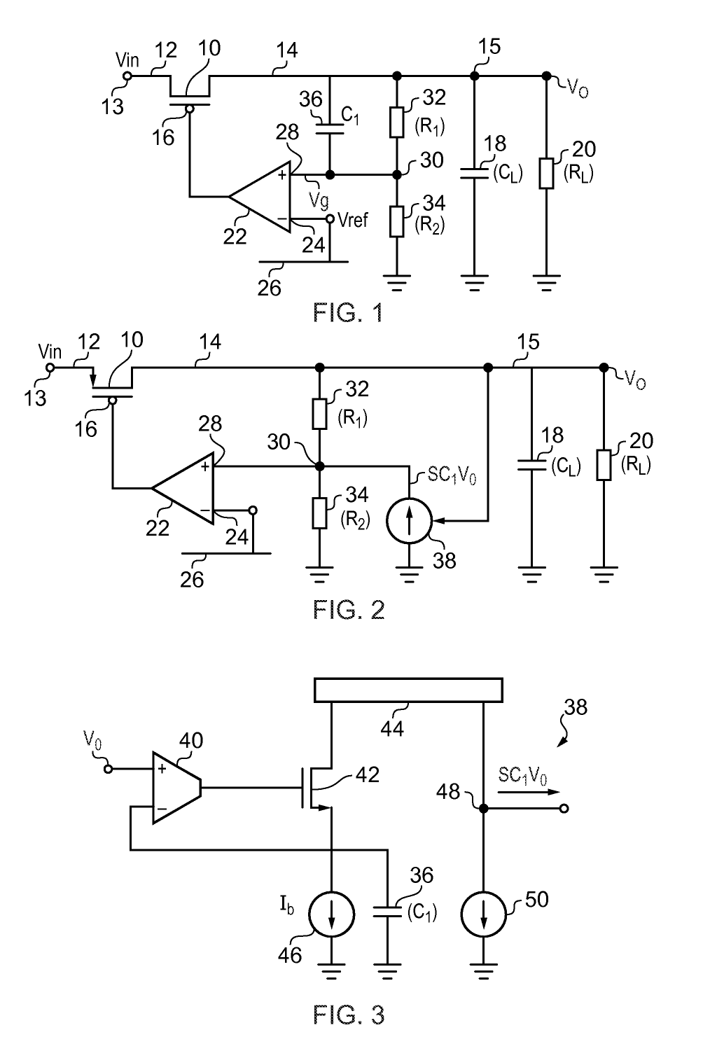

The current trend is to use ceramic capacitors which have very low ESR. This requires that the stability of regulators does not rely any more on the zero contributed by the ESR of the output capacitor. FIG. 1 of the accompanying drawings is a block schematic diagram of an LDO voltage regulator in which an internal zero is introduced in a loop. Referring to FIG. 1, the voltage regulator comprises a PMOS transistor 10 which acts as a current regulating element. The transistor 10 has a source 12 coupled to an input 13 to which an input voltage Vin is applied, a drain 14 coupled to an output 15 from which an output voltage V0 is derived and a gate 16 to which a control or error signal is applied. An external load, represented by a capacitor 18 having a capacitance C_{L} and a resistance 20 having a resistance R_{L}, is connected to the output 15. An error amplifier 22 has an inverting input 24 coupled to a reference voltage line 26 having a voltage Vref, a non-inverting input 28 coupled to a node 30 of a potential divider comprising resistors 32 and 34 connected in series between the output 15 and ground, and an output coupled to the gate 16 of the transistor 10. A voltage Vg is applied to the non-inverting input 28. A capacitor 36 having a capacitance C₁ is connected in parallel with the resistor 32 between the output 15 and the non-inverting input of the error amplifier 22. The capacitor 36 generates an internal zero in the loop formed between the output 15 and the gate 16 of the transistor 10.

Consider the transfer function from the output terminal to the non-inverting input of the error amplifier:

$$\frac{{V}_{g}}{{V}_{o}} = \frac{{R}_{2}}{{R}_{1} + {R}_{2}} \frac{1 + s {R}_{1} {C}_{1}}{1 + s ( {R}_{1} \vert \vert {R}_{2} ) {C}_{1}} \qquad ( 1 )$$

It is seen that a zero is indeed introduced with this capacitor C1, but it also adds a pole which is located, in best case, at only twice frequency apart from the zero. For this reason, this technique does not contribute much to the frequency stability in practical applications.

Another technique has been proposed in an article C. K. Chava and J. Silva-Martinez: “A frequency compensation scheme for LDO voltage regulators”, IEEE Trans. on Circuits and Systems-1, vol. 51, no. 6, pp 1041-1050, June 2004. It is based on the technique shown in FIG. 1, yet without an accompanying pole. FIG. 2 of the accompanying drawings is a block schematic diagram of another LDO voltage regulator. In the interests of brevity FIG. 2 will not be described in detail as features corresponding to those shown in FIG. 1 serve the same function. In FIG. 2 the capacitor 36 has been omitted and a transconductor 38 controlled by the output voltage V0 is provided. An output of the transconductor 38 is coupled to the node 30 of the potential divider 32, 34. The output voltage from the transconductor 38 is represented as sC₁Vo. The transconductance of this transconductor 38 must be proportional to frequency, i.e.:

Gₘ=sC₁ (2)

The implementation of such a transconductor is also proposed in that paper and is shown in FIG. 3 of the accompanying drawings. In FIG. 3 a transconductor 40 has a non-inverting input connected to receive the output voltage Vo, an inverting input and an output. The output is connected to a gate of a nMOS device 42. The drain of the device 42 is connected to a current mirror circuit 44 and the source is connected to a current source 46 and to the inverting input of the transconductor 40. A capacitor 36 having a capacitance Cᵢ is coupled to the inverting input of the transconductor 40. An output of the current mirror 44 is connected to another current source 50. An output current sC₁Vo is derived from a junction 48 of the current mirror 44 output and the current source 50.

Although not mentioned in the above-mentioned article, this technique has a severe problem that affects the utility of the LDO voltage regulator described. Due to device mismatches, which cannot be avoided in any process, the output of the transconductor contains not only the desired output sC₁Vo, but also a DC component. For this reason, the output will contain two terms, as described in equation. (3)

Iₒ=I_{DC}+sC₁Vₒ (3)

It will be noted that I_{DC} is the DC offset current at the output and this term is missing in the abovementioned article. Because the output of the transconductor feeds to the node where two resistors of the sampler join, the output voltage of the regulator, which was set by the ratio of R1 and R2 previously, now falls into disorder, and is subject to this DC offset as well:

$${V}_{o} = ( 1 + \frac{{R}_{1}}{{R}_{2}} ) {V}_{ref} - {I}_{DC} {R}_{1} \qquad ( 4 )$$

The second term is new, representing an error in the output voltage. Because I_{DC} is process and temperature dependent, its value and sign are not well under control, and the output voltage contains an error. To get some numerical feeling, let us consider a practical example. Resistors R1 and R2 are generally in tens of megaohms to reduce the quiescent current. Assuming R1=1 MΩ, and IDC=100 nA, the caused error will be 100 mV, which is huge. From another point of view, the output voltage accuracy of regulators is few percent. For example, Philips PCF5061X and Maxim's MAX8877/MAX8878 families of voltage regulators are specified +/−3%, and +/−3.5%, respectively. Suppose the output voltage accuracy is only caused by this DC offset and the rest is ideal, and consider one sigma, this DC offset current must be kept within:

$${I}_{DC} = \vert 0.01 \frac{{V}_{o}}{{R}_{1}} \vert \qquad ( 5 )$$

For R1=1MΩ and Vo=1.2V, for example, I_{DC} must be smaller than 12 nA. If the errors of the reference voltage, resistor matching, temperature effect, etc are all considered, I_{DC} must be much smaller than this, which is hard to achieve.

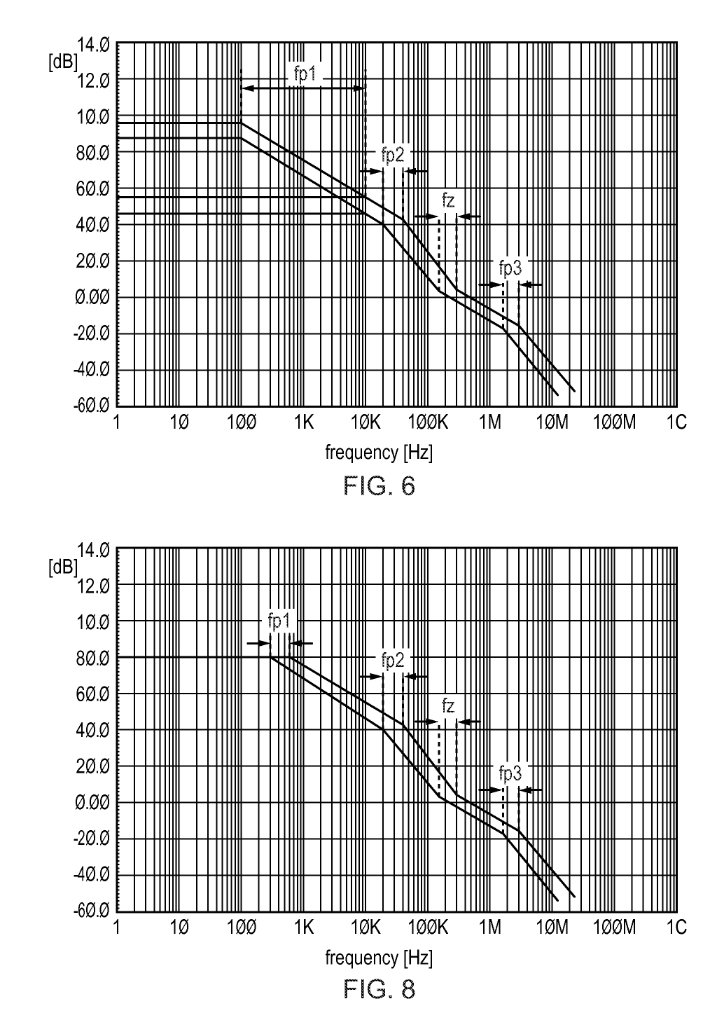

US 2004/0021450 discloses a zero generation circuit for a switching regulator controller. In FIG. 6 of US 2004/0021450 an output voltage from the switching regulator controller is applied to a feedback circuit which provides an error signal to a control logic block. The feedback circuit comprises a voltage divider for dividing down the output voltage. The divided down voltage is coupled to a zero generation circuit comprising a series connected DC blocking capacitor. The alternating current derived from the DC blocking capacitor is applied to an open loop amplifier to the output of which a zero generating capacitor is series connected. The capacitance of the zero generation circuit is multiplied by the gain of the open loop amplifier. The zero produced by the zero generation circuit is summed with the divided down voltage and the summed voltage is applied to an inverting input of an error amplifier, a non-inverting input of which is coupled to a reference voltage source. An output from the error amplifier is fed back to an input of the control logic block. In one variant of the described circuit shown in FIG. 3 the potential divider is shifted to the summing junction. In another variant shown in FIG. 9 the divided down voltage is applied simultaneously to the zero generation circuit and to the inverting input of the error amplifier and the outputs from both are summed and applied to another gain stage which increases the gain of the zero generated.

US 2005/0184711 discloses a LDO voltage regulator including a series connected transistor connected between a regulator input and a regulator output and a feedback path connected between the regulator output and a control electrode of the series transistor. The feedback path includes a potential divider connected to the regulator output and an operational transconductance amplifier having a first non-inverting input connected to receive a divided down voltage from the potential divider, a second inverting input connected to a voltage reference source by way of a resistor and an output connected to the control electrode of the series transistor. A first compensating path comprises a first capacitor connected between the amplifier output and the second inverting input. A second compensating circuit comprises a second capacitor connected between the amplifier output and the regulator output. Poles and zeroes of the transfer function of the LDO voltage regulator in the complex frequency domain represent its frequency response. In the described embodiment the resistor and the first capacitor create an internal zero.

US 2003/0218450 discloses a LDO voltage regulator having an efficient current frequency compensation, a first and a second power supply. The voltage regulator comprises an error amplifier having a power supply input coupled to the first power supply, a non-inverting input coupled to a reference voltage, an inverting input and an output terminal. A voltage divider is connected between the output terminal of the voltage regulator and the inverting input of the error amplifier and is coupled in a feedback loop to the inverting input of the error amplifier. A NMOS pass transistor has a source connected to an output terminal of the voltage regulator, a drain is coupled to the second power supply, and a gate is coupled to the output terminal of the error amplifier. A variable compensation network is connected to the error amplifier in which the variable compensation network includes an RC circuit comprising a resistive transistor and a capacitance coupled in series. A stabilization circuit is coupled between the NMOS pass transistor and the resistive transistor, such that the ratio of the impedance of the NMOS pass transistor to the impedance of the resistive transistor is constant. The RC network comprises a delay phase network which generates a compensation zero and pole. The compensation zero is used to compensate the effect of a second pole in the loop gain.

An object of the present invention is to be able to introduce a zero without adding DC components in the output.

According to a first aspect of the present invention there is provided a low dropout (LDO) voltage regulator comprising a regulating element having an input, an output and a control terminal, an error amplifier having a non-inverting input coupled to means for providing a voltage representative of a voltage at the output of the regulating element, an inverting input coupled to a source of a reference voltage and an output coupled to the control terminal of the regulating element, and means for generating an internal zero, wherein the means for generating an internal zero comprises an operational amplifier having a non-inverting input coupled to the means for providing a voltage representative of the voltage at the output of the regulating element, an output coupled to the non-inverting input of the error amplifier, a resistive element connected between the output and an inverting input of the operational amplifier and a capacitive element coupled between the inverting input of the operational amplifier and the source of reference voltage.

According to a second aspect of the present invention there is provided a method of stabilising a LDO voltage regulator comprising a regulating element having an input for an input voltage, an output for an output voltage and a control terminal, characterised by sampling the output voltage of the regulating element, using the sampled voltage to generate an internal zero, comparing the internal zero with a reference voltage to produce an error voltage, and applying the error voltage to the control terminal.

The LDO voltage regulator made in accordance with the present invention avoids the disadvantages of known circuits by introducing a zero, without adding any DC components in the output. The location of the zero can be put anywhere because it is determined by the product of the resistor and the capacitor without affecting the adjustment of the output voltage.

The present invention will now be described, by way of example, with reference to the accompanying drawings, wherein:

FIG. 1 is a schematic diagram of a first known LDO voltage regulator circuit,

FIG. 2 is a schematic diagram of a second known LDO voltage regulator,

FIG. 3 is a schematic circuit diagram of a transconductor embodied in the circuit shown in FIG. 2,

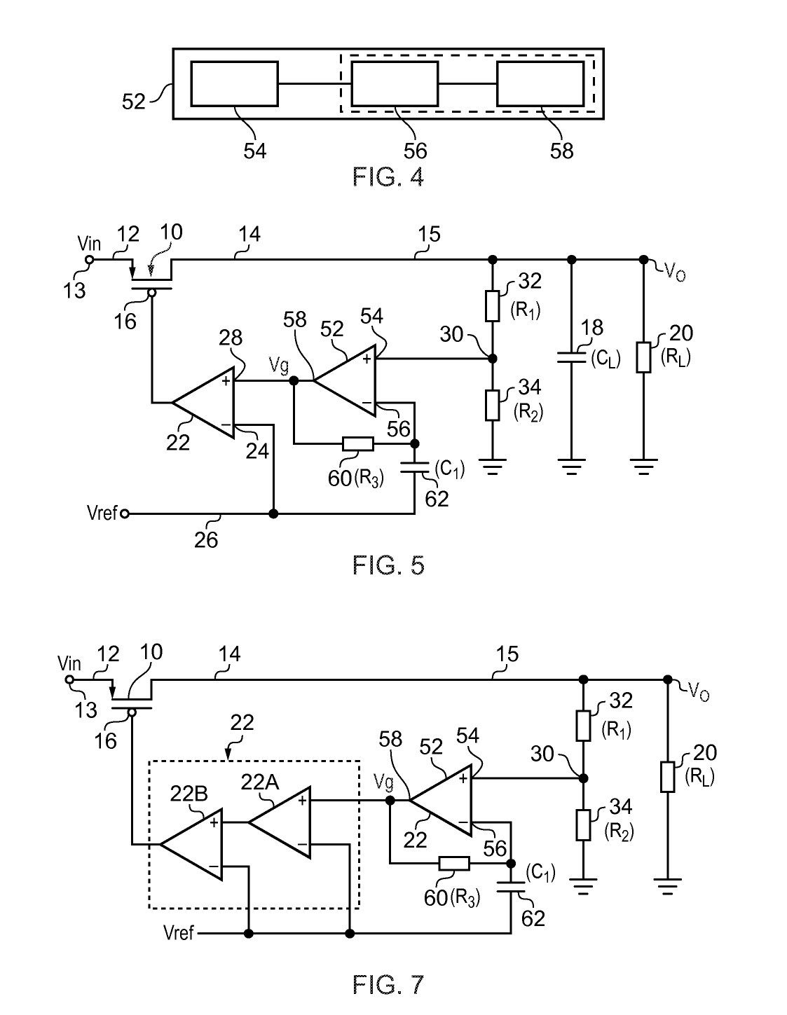

FIG. 4 is a block schematic diagram of an electronic device having a LDO voltage regulator made in accordance with the present invention,

FIG. 5 is a schematic circuit diagram of a LDO voltage regulator made in accordance with the present invention,

FIG. 6 shows frequency response graphs of the LDO voltage regulator with an external load capacitor,

FIG. 7 is a schematic circuit diagram of a modified LDO voltage regulator not having a load capacitor, and

FIG. 8 shows frequency response graphs of the LDO voltage regulator without an external load capacitor.

In the drawings the same reference numerals have been used to indicate corresponding features.

Referring to the drawings, as FIGS. 1 to 3 have been described already in the preamble of the specification they will not be described again.

FIG. 4 illustrates in block schematic form an electronic device 52 including at least one LDO voltage regulator 56 made in accordance with the present invention. The electronic device may comprise a portable device such as a mobile phone, cordless extension phone, MP3 player and a digital still camera. More particularly a power source 54 is connected to the LDO voltage regulator 56 which in turn is connected to a load 58. In the case of portable electronic devices the power source 54 will comprise a battery.

FIG. 5 illustrates an embodiment of a LDO voltage regulator made in accordance with the present invention. The architecture of the LDO voltage regulator resembles that of the circuit shown in FIG. 1 but instead of the capacitor 36 (FIG. 1) and operational amplifier or op-amp 52 with a gain A is coupled between the node 30 of the sampling potential divider formed by the resistors 32, 34 and the non-inverting input 28 of the error amplifier 22. In the interests of brevity only the features of difference between FIGS. 1 and 5 will be described. More particularly the node 30 is connected to a non-inverting input 54 of the op-amp 52. An output 58 of the op-amp 52 is connected to the non-inverting input 28 of the error amplifier 22. A resistor 60 having a value R₃ is connected between the output 58 and an inverting input 56 of the op-amp 52. A capacitor 62 having a value C₁ is connected between the inverting input 56 and the Vref line 26. The transfer function from the voltage output Vo to the voltage Vg at the non-inverting input 28 of the error amplifier 22 can be written as:

$$\frac{Vg}{Vo} = \frac{A}{1 + A} \frac{{R}_{2}}{{R}_{1} + {R}_{2}} \frac{( 1 + s {R}_{3} {C}_{1} )}{1 + \frac{s {R}_{3} {C}_{1}}{1 + A}} \qquad ( 6 )$$

It is seen that a zero is introduced and its location is determined by the time constant of the resistor 60 (R₃) and the capacitor 62 (C₁). A pole is added too, but it is located at much higher frequencies and can be neglected if A is large enough. With this frequency compensation method, the designer has full freedom to put the zero anywhere he or she wants to make the regulator stable, and gets rid of the troubling DC component completely from the output. Because an op-amp is normally simpler than the transconductor 38 shown in FIG. 3, and there are no linearity issues, the design of an op-amp is easier than a transconductor. Let us now consider the effect of offset from the two op-amps. The output voltage can be expressed as:

$$V o = ( 1 + \frac{{R}_{1}}{{R}_{2}} ) ( Vref + Voffset 1 + Voffset 2 ) \qquad ( 7 )$$

where Voffset1 and Voffset2 are the input referred offsets of the compensation op-amp 52, and the error amplifier 22, respectively. From above, for a +/−3% accuracy at Vo=1.2V, the allowed total error is +/−36 mV. Again if we consider one sigma, it is +/−12 mV. This error may be distributed to the resistor ratio R1/R2, reference voltage Vref, and Voffset1 and Voffset2, respectively.

Because the input offset of a properly designed op-amp can be kept within 1-2 mV, the accuracy specification can be fulfilled without calling for offset calibration. In fact, output voltage accuracy is not a key performance parameter for regulators. Some device manufacturers do not even specify their regulator products with respect to output voltage accuracy.

In the next section, we'll show that this compensation technique makes regulators stable with any load capacitance, i.e., with or without an external capacitor. Three cases will be discussed:

1. With an added external load capacitor
2. No external load capacitor added, and
3. No external load capacitor connected, however, due to parasitic capacitance a lumped capacitor present.

To check the stability and evaluate the phase margin, we'll refer to Bode diagram or gain curve of regulators, and take the data given in the IEEE Trans. On Circuits and Systems referred to in the preamble for discussion. For a two-pole system, a zero is added where appropriate to make regulators stable.

Note that the fundamental requirement for stability is that the zero must be located below the loop's unity-gain frequency, and all high-frequency poles must be located at least three times the unity-gain frequency.

### 1 With an External Load Capacitor CL

In this case, the open-loop gain transfer function of a typical regulator is given by:

$$H ( s ) = \frac{{A}_{0}}{( 1 + \frac{s}{{ω}_{p 1}} ) ( 1 + \frac{s}{{ω}_{p 2}} )} \qquad ( 8 )$$

where A₀ is the dc open-loop gain, and it is the product of dc gain of the error amplifier, pass transistor and feedback loop. If the gate-drain capacitance of the pass transistor is small, the two poles are located at the following frequencies:

$${ω}_{p 1} = \frac{1}{[ {r}_{ds} ‖ ( R 1 + R 2 ) ‖ {R}_{L} ] {C}_{L}} \\ {ω}_{p 2} = \frac{1}{{R}_{g} \{ {C}_{g} + {g}_{m} [ {r}_{ds} ‖ ( R 1 + R 2 ) ‖ {R}_{L} ] {C}_{gd} \}} \qquad ( 9 )$$

where r_{ds}, gₘ, and C_{gd} are the output resistance, transconductance, and gate-to-drain capacitance of the pass transistor, and R_{g} and C_{g} are the lumped resistance and capacitance at the output of the error amplifier (also at the gate of the pass transistor. In the above, it was assumed that the error amplifier has only a single pole at its output. In fact, it has a second pole or even a third pole but they are disregarded here as they are assumed to be at higher frequencies.

From equations. 6 and 7 it is clear that voltage regulators are potentially unstable as they have, at least, two poles. By introducing a zero below the unity-gain frequency of the open-loop gain transfer function, the regulator can be stabilized. We are going to demonstrate this with typical element values given in the IEEE Trans. On Circuits and Systems referred to in the preamble:

Dominant pole frequency fₚ₁=100 Hz-10 kHz

Second pole frequency fₚ₂=20 kHz-50 kHz

Unity-gain frequency fᵤ=250 kHz-650 kHz

These are shown in FIG. 6. Here, we assume the zero frequency fᵤ=147 kHz-382 kHz, and the third pole is located at least above 1.7 MHz and the rest poles above 10fᵤ. Under this assumption, the regulator is stable with a phase margin of at least 60 degrees. The unity gain frequency fᵤ is the frequency at which the gain is 1 (unity) in linear or) in dB.

### 2 No External Load Capacitor, CL=0

As mentioned earlier, the stability of most commercial regulator products today still relies on a zero generated by the load capacitor and its ESR. However, cost, weight and space can be reduced if this external load capacitor can be avoided and at the same time the stability of the regulator is not affected. Such a regulator can be desirable for those circuits where the supply current is a constant DC.

With absence of an external load capacitor, the previous mentioned first pole (fp1) does not exist any more and the second pole, located about 20 kHz to 50 kHz, suddenly becomes the dominant pole. However, the regulator now does not become a single-pole system and its gain curve does not roll off with −20 dB/decade across the frequency axis. If it did, this would mean that for a regulator with 80 dB DC gain, for example, its unity-gain frequency would be at 200 MHz-500 MHz! This is certainly not possible because there are other poles, which were neglected before, that lie well below the would-be unity-gain frequency.

It is possible to think of shifting the pole from 20 kHz-50 kHz downwards to a very low frequency and hope the regulator be stable while maintaining the unity-gain frequency. To show why this is not possible in practice, let us again assume the same DC gain of 80 dB. Now, the pole must be shifted to low frequency by as much as 4 decades. That is a factor of 10000. Therefore, the product of Rg and Cg must be increased by the same factor. Unfortunately, it is not possible to increase Rg alone by this amount even if the output transistor is cascoded, due to large output transistors used and high current. In this case, one may think of increasing the capacitor Cg as well. This is not a good idea, either, because any increase in node capacitance will lead to a decrease of the unity-gain frequency, which we want to avoid. In addition, larger capacitor means more silicon area. Another problem is the fact that cascode current mirror introduces additional poles and reduces output swing range, which are negative to the error amplifier.

Referring to FIG. 7 it will be demonstrated that the proposed method can be used to stabilize regulators without a load capacitor. First, a dominant pole is added to the loop. This can be simply and easily done if the error amplifier 22 is replaced by a typical two-stage op-amp 22A, 22B. Using a two-stage op-amp as error amplifier has many advantages: First, it has higher gain. Secondly, it is probably the most frequently used op-amp and a two-pole modelling is quite accurate. Third, an existing op-amp can be tailored with less effort.

By using a two-stage error amplifier, the gain curve of the regulator may look like the one shown in FIG. 8. Note that now the range of fp1 is smaller as it is independent of the regulator's loading. As before, there are two poles below the unity-gain frequency, calling for frequency compensation. The proposed stabilising method can be applied. As before, we can place the zero below the unity-gain frequency, and make sure that all other poles are above the unity-gain frequency, and there is enough phase margin, as we treated regulator with a load capacitor previously.

### 3 Parasitic Capacitance Considered but No External Load Capacitor Added

Although no external load capacitor is added, a voltage regulator can still see some capacitance into the power supply terminal of any circuit. This is a lumped capacitor representing all parasitic capacitances at the power supply terminal of the circuit, for example, N-well to substrate capacitance and tie-off cell capacitance, etc. The value of this capacitance depends on the design and process technology used. This means that the pole, fp1, can be either below, or above the unity-gain frequency.

Accordingly, it can be treated similarly either as a regulator with load capacitor, or no capacitor at all, and use the proposed compensation method to make the regulator stable. For detailed procedure refer to Sections 1 and 2 above.

In the present specification and claims the word “a” or “an” preceding an element does not exclude the presence of a plurality of such elements. Further, the word “comprising” does not exclude the presence of other elements or steps than those listed.

The use of any reference signs placed between parentheses in the claims shall not be construed as limiting the scope of the claims.

From reading the present disclosure, other modifications will be apparent to persons skilled in the art. Such modifications may involve other features which are already known in the design, manufacture and use of LDO voltage regulators therefor and which may be used instead of or in addition to features already described herein.

1. A low dropout voltage regulator comprising:
a regulating element having an input, an output and a control terminal,
means for providing a voltage representative of a voltage at the output of the regulating element
an error amplifier having a non-inverting input coupled to the means for providing a voltage representative of a voltage at the output of the regulating element,
an inverting input coupled to a source of a reference voltage and an output coupled to the control terminal of the regulating element, and
means for generating an internal zero, wherein the means for generating an internal zero comprises an operational amplifier having a non-inverting input coupled to the means for providing a voltage representative of the voltage Vo at the output of the regulating element, an output coupled to the non-inverting input of the error amplifier, a resistive element connected between the output and an inverting input of the operational amplifier and a capacitive element coupled between the inverting input of the operational amplifier and the source of reference voltage.

2. A LDO voltage regulator as in claim 1, further comprising a potential divider coupled to the output of the regulating element, the potential divider having a node for deriving the voltage representative of the voltage at the output of the regulating element.

3. A LDO voltage regulator as in claim 1, further comprising an external capacitor coupled to an output of the regulating element.

4. A LDO voltage regulator as in claim 1, wherein the regulating element comprises a PMOS device.

5. A LDO voltage regulator as in claim 1, wherein the error amplifier comprises a two stage operational amplifier.

6. An apparatus including at least one LDO voltage regulator as in claim 1.

7. A method of stabilising a LDO voltage regulator including a regulating element having an input for an input voltage, an output for an output voltage and a control terminal, comprising:
sampling the output voltage of the regulating element,
using the sampled voltage to generate an internal zero,
comparing the internal zero with a reference voltage to produce an error voltage, and
applying the error voltage to the control terminal.
